(19) United States
(12) Patent Application Publication
(10) Pub. No.: US 2009/0193784 A1
(43) Pub. Date: Aug. 6, 2009

(54) POWER GENERATING TURBINE SYSTEMS

(75) Inventors: Gunnar L. Siden, Greenville, SC (US); Sal A. Leone, Scotia, NY (US); John E. Sholes, Kings Mountain, NC (US); Victor G. Hatman, Easley, SC (US); Douglas C. Hofer, Clifton Park, NY (US); Thomas W. Vandeputte, Simpsonville, SC (US); Sylvain Pierre, Greer, SC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 12/023,319

(22) Filed: Jan. 31, 2008

(51) Int. Cl. F02C 6/04

(52) U.S. Cl. 60/39.15; 290/52

(57) ABSTRACT

A power generating turbine system that may include: 1) a turbine that includes two sections, a high-pressure turbine section and a low-pressure turbine section that each reside on a separate shaft; 2) an axial compressor that compresses a flow of air that is then mixed with a fuel and combusted in a combustor such that the resulting flow of hot gas is directed through the turbine; 3) a two-pole generator; 4) a four-pole generator; 5) a first shaft that couples the high-pressure turbine section to the axial compressor and the two-pole generator such that, in operation, the high-pressure turbine section drives the axial compressor and the two-pole generator; and 6) a second shaft that couples the low-pressure turbine section to the four-pole generator such that, in operation, the low-pressure turbine section drives the four-pole generator.

### BACKGROUND OF THE INVENTION

This present application relates generally to turbine engines and systems. More specifically, but not by way of limitation, the present application relates to systems for enhancing turbine performance by use of, among other things, multi-shaft arrangements and/or half-speed generators.

With rising energy cost and increasing demand, the objective of improving the efficiency of gas turbines is always a significant one. Toward this aim, larger gas turbines capable of handling increased mass flow have been proposed as a way of increasing power generation efficiency. However, gas turbines used in power generation are generally constrained in size because of the interplay of two factors. First, power generating gas turbines generally operate at the same frequency of the AC power grid to avoid the need for a reducing gearbox. As a result, because much of the world distributes AC power at either a 50 or 60 Hz frequency, the operating frequency for power generating gas turbines is restricted to either 50 or 60 Hz. (Note, for the sake of brevity and clarity, hereinafter the two most common power generating frequencies, i.e., 50 Hz and 60 Hz, will be referred to as 60 Hz. Unless otherwise stated, it is understood that a reference to a 60 Hz frequency is also inclusive of a reference to the 50 Hz frequency as well as similar frequencies that may be used in an AC power grid.)

The second factor is the inability of current materials to withstand the centrifugal stresses associated with the rotating parts of larger turbines. As turbines increase in size and mass flow, the rotating parts of the turbine necessarily must also increase in size and weight. However, for the rotating parts, such as the turbine buckets, this increase in size and weight causes these parts to experience a significant increase in centrifugal stress if the normal operating frequency of 50-60 Hz is maintained. As one of ordinary skill in the art will appreciate, this condition is especially troublesome for the larger and heavier turbine buckets of the low pressure or aft stages of the turbine. In the forward sections of the compressor, where the larger compressor blades reside, excessive centrifugal stresses similarly may be a limiting problem. Thus, current material limitations make it impossible or prohibitively expensive to manufacture parts that will operate successfully in these larger turbines.

The combination of these two issues generally limit the size at which power generating turbines may cost effectively be constructed. As a result, larger and more efficient turbines are not implemented. Thus, there is a need for improved methods and systems of turbine operation that will allow larger turbines to be constructed and operated in a cost effective manner.

### BRIEF DESCRIPTION OF THE INVENTION

The present application thus may describe a power generating turbine system that may include an axial compressor that compresses a flow of air that is then mixed with a fuel and combusted in a combustor such that the resulting flow of hot gas is directed through a turbine. The turbine may include a low-pressure turbine section and a high-pressure turbine section. The high-pressure turbine section may coupled via a first shaft to the axial compressor such that in operation the high-pressure turbine section drives at least a part of the axial compressor. The high-pressure turbine section may be coupled via the first shaft to a high-speed generator such that in operation the low-pressure turbine section drives the high-speed generator. And, the low-pressure turbine section may be coupled via a second shaft to a low-speed generator such that in operation the low-pressure turbine section drives the low-speed generator.

The present application further describes a power generating turbine system that may include: 1) a turbine that includes two sections, a high-pressure turbine section and a low-pressure turbine section that each reside on a separate shaft; 2) an axial compressor that compresses a flow of air that is then mixed with a fuel and combusted in a combustor such that the resulting flow of hot gas is directed through the turbine; 3) a two-pole generator; 4) a four-pole generator; 5) a first shaft that couples the high-pressure turbine section to the axial compressor and the two-pole generator such that, in operation, the high-pressure turbine section drives the axial compressor and the two-pole generator; and 6) a second shaft that couples the low-pressure turbine section to the four-pole generator such that, in operation, the low-pressure turbine section drives the four-pole generator.

These and other features of the present application will become apparent upon review of the following detailed description of the preferred embodiments when taken in conjunction with the drawings and the appended claims.

### BRIEF DESCRIPTION OF THE DRAWINGS

FIG. 1 is a schematic drawing illustrating the configuration of a power generating turbine system according to conventional design.

FIG. 2 is a schematic drawing illustrating the configuration of a power generating turbine system according to an embodiment of the present application.

FIG. 3 is a schematic drawing illustrating the configuration of a power generating turbine system according to an alternative embodiment of the present application.

FIG. 4 is a schematic drawing illustrating the configuration of a power generating turbine system according to an alternative embodiment of the present application.

FIG. 5 is a schematic drawing illustrating the configuration of a power generating turbine system according to an alternative embodiment of the present application.

FIG. 6 is a schematic drawing illustrating the configuration of a power generating turbine system according to an alternative embodiment of the present application.

FIG. 7 is a schematic drawing Illustrating the configuration of a power generating turbine system according to an alternative embodiment of the present application.

FIG. 8 is a schematic drawing illustrating the configuration of a power generating turbine system according to an alternative embodiment of the present application.

FIG. 9 is a schematic drawing illustrating the configuration of a power generating turbine system according to an alternative embodiment of the present application.

### DETAILED DESCRIPTION OF THE INVENTION

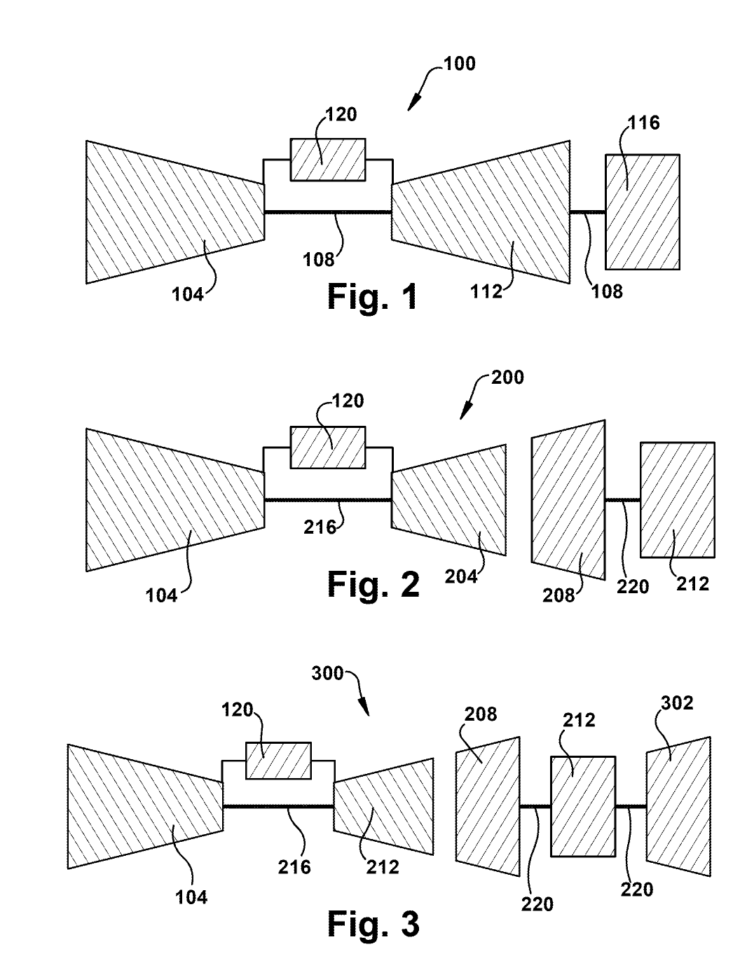

Referring now to the figures, where the various numbers represent like parts throughout the several views, FIG. 1 is a schematic drawing illustrating the configuration of a power generating turbine system of the prior art. In general, a gas turbine engine extracts energy from a flow of hot gas produced by combustion of gas or fuel oil in a stream of compressed air. As such, the gas turbine engine 100 includes an upstream axial compressor or compressor 104 mechanically coupled by a single or common shaft 108 to a downstream turbine 112 and a generator 116 with a combustor 120 positioned between the compressor 104 and the turbine 112.

In use, the rotation of compressor blades within the axial compressor 104 may compress a flow of air. Energy then may be released when the compressed air is mixed with fuel and ignited in the combustor 120. The resulting flow of expanding hot gases from the combustor then may be directed over the blades or buckets within the turbine 112, thus transforming the energy of the hot flow of gases into the mechanical energy of the rotating shaft 108. As described, the common shaft 108 may couple the compressor 104 to the turbine 112 so that the rotation of the shaft 108 induced by the flow through the turbine 112 may drive the compressor 104. The common shaft 108 also may couple the turbine 112 to the generator 116 so that the rotation of the shaft 108 induced by the flow through the turbine 112 may drive the generator 116.

The generator 116 converts the mechanical energy of the rotating shaft into electrical energy. Typically, in power generating applications, the generator 116 is a two-pole generator. As one of ordinary skill in the art will appreciate, absent a gear box—which generally adds complexity, cost and inefficiency to the system—the shaft 108 must drive the two-pole generator at a frequency of 60 Hz to generate electrical energy that is compatible with the local AC power grid. Thus, the requirements of the AC power grid, the use of two-pole generators, and the negatives associated with using a gear box, generally require turbine engines to operate at the 60 Hz frequency. As described above, turbines engines that operate near such a high frequency level are generally limited in size and mass flow capabilities because of the high level centrifugal stresses applied to their rotating parts.

FIG. 2 is a schematic drawing illustrating the configuration of a power generating turbine system 200 according to an embodiment of the present application. (Note that throughout the description of FIGS. 2-9 various system components will be described. These system components will include generators, turbines, steam turbines, combustors, compressors, and multiple shafts. Except where otherwise stated, it is intended that the descriptions of the system components be construed broadly to include all variations of each. Further, as used herein, “turbine” generally refers to the turbine section of a gas turbine engine while “steam turbine” refers to the turbine section of a steam turbine engine.) The turbine system 200 may include a compressor 104, a combustor 120, a turbine with a high-pressure turbine section 204 and a low-pressure turbine section 208, and a low-speed generator 212. As used herein, a “low-pressure turbine section” and a “high-pressure turbine section” designations are meant to differentiate the respective operating pressure levels of each as compared to the other (i.e., the forward stages of a typical turbine might be said to be the “high-pressure turbine section” and the aft stages might be said to be the “low-pressure turbine section” because as the working fluid expands through the turbine—first through the forward section and then through the aft section—the pressure of the flow decreases). Thus, except where otherwise stated, this terminology is not meant to be limiting in any other way. Further, as used herein, a “high-speed generator” shall be construed to be a conventional two-pole generator commonly used in power generating applications. A “low-speed generator” shall be construed to be a generator that has more than two poles, for example, a four-poles generator, a six-pole generator, an eight-pole generator, etc.

In a conventional manner, the compressor 104 may be coupled via a first shaft 216 to the high-pressure turbine section 204 such that in operation the high-pressure turbine section 204 drives the axial compressor. In the same manner, the low-pressure turbine section 208 may be coupled via a second shaft 220 to a low-speed generator 212 such that in operation the low-pressure turbine section 208 drives the low-speed generator 212. In some embodiments, the high-pressure turbine section 204 may include between 1 to 2 stages and the low-pressure turbine section 208 may include between 2 to 4 stages. Further, in some embodiments, the high-pressure turbine section 204 may be defined to include the stages of a turbine that are configured to operate when the pressure of the flow of expanding hot gases (i.e., the working fluid) is between approximately 260 to 450 psi. Also, in some embodiments, the low-pressure turbine section 208 may be defined to include the stages of a turbine that are configured to operate when the pressure of the working fluid is between approximately 50 to 150 psi.

In use, the power generating turbine system 200 may operate as follows. The rotation of compressor blades within the axial compressor 104 may compress a flow of air. Energy then may be released when the compressed air is mixed with fuel and ignited in the combustor 120. The resulting flow of expanding hot gases from the combustor 120 then may be directed over the buckets within the high-pressure turbine section 204, thus transforming the energy of the hot flow of gases into the mechanical energy of the rotating first shaft 216. The first shaft 216 may be coupled to the axial compressor 104 so that the rotation of the shaft 216 induced by the flow of working fluid through the high-pressure turbine section 204 may drive the axial compressor 104. Because the high-pressure turbine section 204 is not coupled to a generator, its operating frequency is not constrained to any particular level, which thus may allow it to operate at whatever frequency is most efficient for the system. In some embodiments, the operating frequency for the high-pressure turbine section 204 may be at least approximately 50 Hz. Of course, with no gear box in the system, the operating frequency of the axial compressor 104 will be the same as the frequency of the high-pressure turbine section 204. In other embodiments, the operating frequency for the high-pressure turbine section 204 may be at least 70 Hz.

After the flow of working fluid has expanded through the high-pressure turbine section 204, the working fluid then may be directed through the low-pressure turbine section 208. Similar to the process described above, the flow of the working fluid may be directed over the bucket stages within the low-pressure turbine section 208, thus transforming the energy of the flowing working fluid into the mechanical energy of the rotating second shaft 220. The second shaft 220 may couple the low-pressure turbine section 208 to the low-speed generator 212 so that the rotation of the second shaft 220 induced by the flow of working fluid through the low-pressure turbine section 208 may drive the low-speed generator 212.

As stated, the low-speed generator 212 may be a generator that has greater than two poles such that the low-speed generator 212 may output electrical energy at a frequency that is compatible with the local AC power grid while receiving a shaft frequency that is much slower. Thus, for example, in the case where the low-speed generator 212 is a four-pole generator, the low-speed turbine section 208 could be operated at reduced frequency of 30 Hz and still produce AC power frequency of 60 Hz, which would be compatible with the AC power grid. That is, the 30 Hz operating frequency of the low-speed turbine section 208 would drive the second shaft 220 at a 30 Hz frequency that, in turn, would drive the four-pole generator at a 30 Hz frequency. The four-pole generator then would output AC power at 60 Hz. In a similar manner, the same results (i.e., an output of compatible AC power at or about the 60 Hz frequency) may be achieved with slower operating frequencies for low-speed turbine section 208 if a six-pole generator or an eight-pole generator were used. Of course, generators of more poles also are possible.

As described, because the pressure of the working fluid is much decreased by the time the flow reaches the aft stages of the turbine, the rotating parts in this area, especially the buckets, must be made significantly larger to effectively capture the remaining energy of the working fluid. Of course, as the size of the rotating parts becomes ever larger, the levels of the centrifugal stress experienced by the rotating parts also increases and eventually becomes prohibitive given the operational limitations of the available materials. This, as discussed, may limit the continued growth of turbine engine size and flow capacities, even though such growth would result in more efficient power generation. However, by using the low-speed generator 212, the low-pressure turbine section 208 may generate compatible AC power at reduced operating frequencies. The reductions in frequency significantly reduce the centrifugal stress on the rotating parts, allowing the parts to grow in size. This allows greater turbine engine size and flow capacities to be achieved. Further, the use of multiple shafts by the power generating turbine system 200, i.e., the first shaft 216 and the second shaft 220, allows the high-pressure turbine section 204 (which, because of the higher pressures through this section, function effectively with smaller rotating parts that lessen the issue of excessive centrifugal stresses) to operate at a different higher (more efficient) frequency than the low-pressure turbine section 204.

FIG. 3 is a schematic drawing illustrating the configuration of a power generating turbine system 300 according to an alternative embodiment of the present application. The power generating turbine system 300 may contain the same system components as the power generating turbine system 200 except for the addition of a steam turbine 302. As one of ordinary skill in the art will appreciate, for example, waste heat from a gas turbine engine may be recovered by a heat recovery steam generator to power a conventional steam turbine. As described in more detail below, the steam turbine 302, in some embodiments, may be a low-pressure steam turbine. As used herein, a “low-pressure steam turbine” is defined generally as a steam turbine that includes only the lower pressure or aft stages of a convention steam turbine. The steam turbine 302 may be coupled via the second shaft to the low-speed generator 212 such that in operation both the low-pressure turbine section 208 and the low-pressure steam turbine 302 drive the low-speed generator 212. Accordingly, the steam turbine 302 may operate at the same frequencies as those described for the low-pressure turbine section 208 (i.e., if the low-speed generator 212 is a four-pole generator, the steam turbine 302 may operate at a 30 Hz frequency). Generally, in other regards, the system components of the power generating turbine system 300 may operate similarly to that described herein for the same system components in the other embodiments.

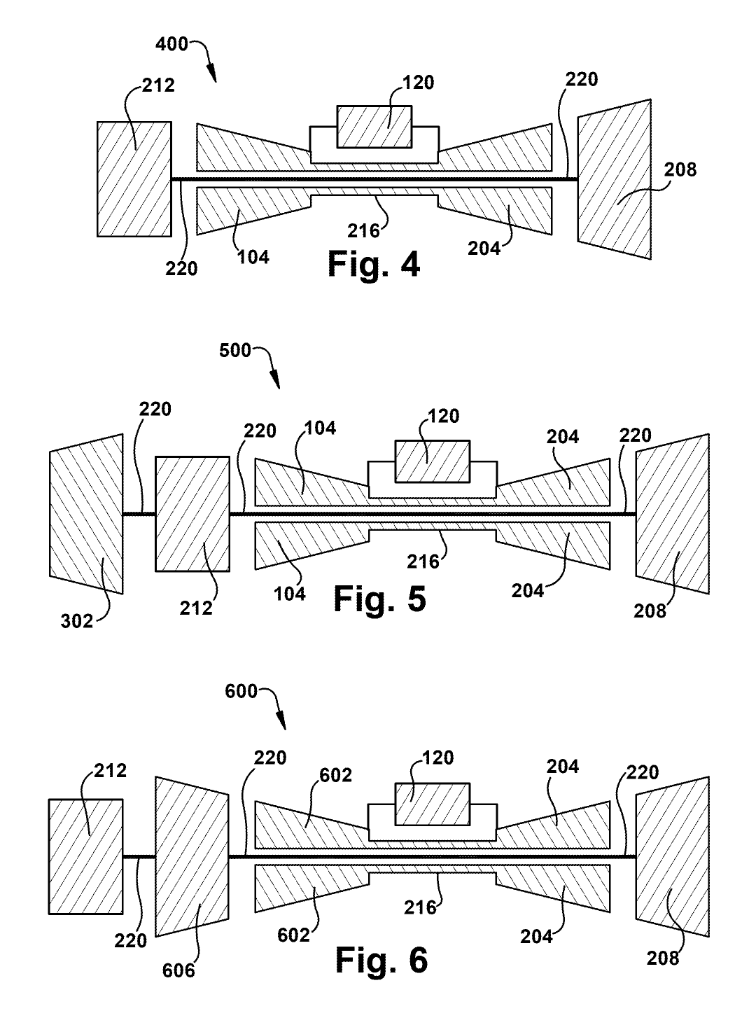

FIG. 4 is a schematic drawing illustrating the configuration of a power generating turbine system 400 according to an alternative embodiment of the present application. The embodiment illustrated in FIG. 4 generally contains the same system components as the power generating turbine system 200 in FIG. 2, but the location of the low-speed generator 212 has been modified. In FIG. 2, because the low-speed generator 212 is on the same side as the turbine sections 204,208, the low-speed generator is said to be located on the “hot-side.” In FIG. 4, because the low-speed generator 212 is on the same side as the axial compressor 104, the low-speed generator is said to be located on the “cold-side.” As one of ordinary skill in the art will appreciate, as illustrated in FIG. 4, the first shaft 216 and second shaft 220 function independently of each other and at different frequencies (i.e., as illustrated, the second shaft 220 is inside the first shaft 216). Generally, in other regards, the system components of the power generating turbine system 400 may operate similarly to that described herein for the same system components in the other embodiments.

FIG. 5 is a schematic drawing illustrating the configuration of a power generating turbine system 500 according to an alternative embodiment of the present application. The embodiment illustrated in FIG. 5 generally contains the same system components as the power generating turbine system 300 of FIG. 3, however, the locations of the low-speed generator 212 and the low-speed steam turbine 302 have been modified. In FIG. 5, both the low-speed generator 212 and the low-pressure steam turbine 302 are located on the cold-side. Generally, in other regards, the system components of the power generating turbine system 500 may operate similarly to that described herein for the same system components in the other embodiments.

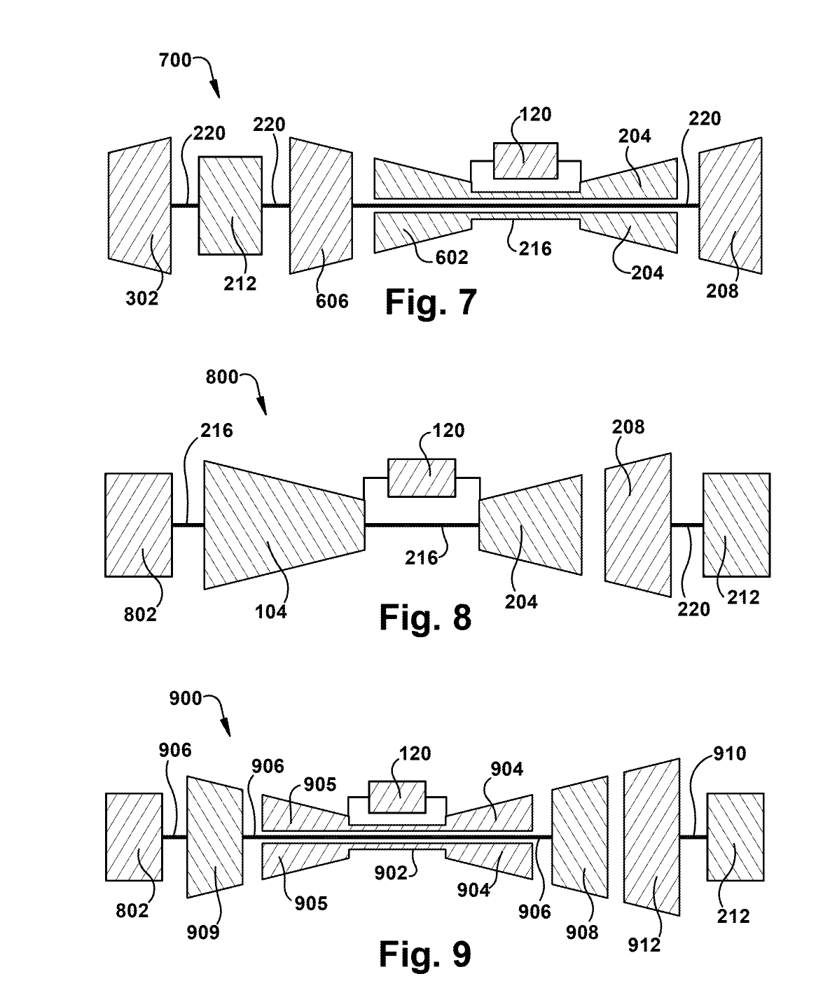

FIG. 6 and FIG. 7 are schematic drawings illustrating a power generating turbine system 600 and a power generating turbine system 700, respectively, according to alternative embodiments of the present application. Both FIGS. 6 and 7 illustrate embodiments wherein the axial compressor includes a high-pressure compressor section 602 and a low-pressure compressor section 606 that reside on separate shafts. As discussed in more detail below, having separate shafts may allow each of the compressor sections to operate at different frequencies and be driven by different compressor sections for enhanced operation.

Referring now to the embodiment of FIG. 6, in a conventional manner, a first shaft 216 may couple the high pressure compressor section 602 to a high-pressure turbine section 204. A second shaft 220 may couple a low-pressure turbine section 208 to the low-pressure compressor section 606. In addition, the second shaft 220 may couple the low-pressure turbine section 208 to a low-speed generator 212. Note that in the embodiment of FIG. 6, the low-speed generator 212 is positioned on the cold-side. In alternative embodiments, the low-speed generator 212 also may be positioned on the hot-sided.

In use, the power generating turbine system 600 may operate as follows. The rotation of compressor blades within the high-pressure compressor section 602 and the low-pressure compressor section 606 may compress a flow of air. Energy then may be released when the compressed air is mixed with fuel and ignited in the combustor 120. The resulting flow of expanding hot gases from the combustor 120 then may be directed over the buckets within the high-pressure turbine section 204, thus transforming the energy contained in the hot flow of gases into the mechanical energy of the rotating first shaft 216. The first shaft 216 may be coupled to the high-pressure compressor section 602 so that the rotation of the shaft 216 induced by the flow of working fluid through the high-pressure turbine section 204 drives the high-pressure compressor section 602. Because the high-pressure turbine section 204 is not coupled to a generator, its operating frequency is not constrained to any particular level, which thus may allow it to operate at whatever frequency is most efficient for the system. In some embodiments, the operating frequency for the high-pressure turbine section 204 may be at least approximately 50 Hz. Of course, with no gear box in the system, the operating frequency of the high-pressure compressor section 602 will be the same as the frequency of the high-pressure turbine section 204. In other embodiments, the operating frequency for the high-pressure turbine section 204 may be at least approximately 70 Hz. In still other embodiments, the high-pressure compressor section may have between 1 to 2 stages and the low-pressure compressor section have between 2 to 4 stages.

After the flow of working fluid has expanded through the high-pressure turbine section 204, the flow may then be directed through the low-pressure turbine section 208. Similar to the process described above, the flow of the working fluid may be directed over the bucket stages within the low-pressure turbine section 208, thus transforming the energy contained in the working fluid into the mechanical energy of the rotating second shaft 220. The second shaft 220 may couple the low-pressure turbine section 208 to the low-speed generator 212 so that the rotation of the second shaft 220 induced by the flow of working fluid through the low-pressure turbine section 208 drives the low-speed generator 212.

As described in more detail above, the low-speed generator 212 may be a generator that has greater than two poles such that the low-speed generator 212 may output electrical energy at a frequency that is compatible with the local AC power grid while receiving a shaft frequency that is much slower. Thus, for example, in the case where the low-speed generator 212 is a four-pole generator, the low-speed turbine section 208 could be operated at reduced frequency of 30 Hz and still produce AC power frequency of 60 Hz, which would be compatible with the AC power grid.

The second shaft 220 also may couple the low-speed turbine section 208 to the low-speed compressor section 606 so that the rotation of the second shaft 220 induced by the flow of working fluid through the low-pressure turbine section 208 drives the low-speed compressor 606. As previously described, the issue of high frequency rates and larger rotating part sizes is not confined to the turbine section of the engine, as it may also be an issue in the compressor. As the rotating blades of the compressor grow larger to accommodate larger turbine power systems and flow capacities, excessive centrifugal stress becomes an issue. This is especially true for the forward low-pressure stages of the compressor, where larger compressor blades are necessary.

This issue may be effectively resolved if the low-pressure compressor section 606 is rotated on a separate shaft at a lower frequency than the higher pressure stages at the aft end of the compressor. As such, the second shaft 220 may couple the low-pressure turbine section 208 to the low-pressure compressor section 606. In this manner, the low-pressure compressor section 606 may be used effectively to boost compression through the compressor while operating at a reduced frequency such that the size of the rotating parts is not limited. Generally, in other regards, the system components of the power generating turbine system 600 may operate similarly to that described herein for the same system components in the other embodiments.

FIG. 7 also illustrates an embodiment wherein the axial compressor includes a high-pressure compressor section 602 and a low-pressure compressor section 606 that reside on separate shafts. The power generating turbine system 700 includes a low-pressure steam turbine 302 that is coupled to the low-speed power generator 212, the low-pressure compressor section 606 and the low-pressure turbine section 208 via the second shaft 220. Note that in the embodiment of FIG. 7, the low-pressure steam turbine 302 is positioned on the cold-side. In alternative embodiments, the low-pressure steam turbine 302 may be positioned on the hot-sided. In use, the low-pressure steam turbine 302 may operate to drive the low-speed generator 212 and the low-pressure compressor section 606 at a reduced frequency, as described above in relation to other embodiments that include the low-pressure steam turbine. Generally, in other regards, the system components of the power generating turbine system 700 may operate similarly to that described herein for the same system components in the other embodiments.

FIG. 8 is a schematic drawing illustrating a power generating turbine system 800 according to an alternative embodiment of the present application. As illustrated, in a conventional manner, a first shaft 216 may couple a high-pressure turbine section 204 to an axial compressor 104. The first shaft 216 also may couple the high-pressure turbine section 204 to a high-speed generator 802. A second shaft 220 may couple a low-pressure turbine section 208 to a low-speed generator 212. Note that in the embodiment of FIG. 8, the low-speed generator 212 is positioned on the hot-side and the high-speed generator 802 is positioned on the cold-side. In alternative embodiments, other positions are possible.

In use, the power generating turbine system 800 may operate as follows. The rotation of compressor blades within the compressor 104 may compress a flow of air. Energy then may be released when the compressed air is mixed with fuel and ignited in the combustor 120. The resulting flow of expanding hot gases from the combustor 120 then may be directed over the buckets within the high-pressure turbine section 204, thus transforming the energy contained in the hot flow of gases into the mechanical energy of the rotating first shaft 216. The first shaft 216 may be coupled to the compressor 104 so that the rotation of the shaft 216 induced by the flow of working fluid through the high-pressure turbine section 204 drives the compressor 104. The first shaft 216 also may be coupled to the high-speed generator 802 so that the rotation of the shaft 216 induced by the flow of working fluid through the high-pressure turbine section 204 drives the high-speed generator 802. In some embodiments, because the high-pressure turbine section 204 is coupled to the high-speed generator 802, its operating frequency may be 60 Hz such that electrical energy produced by the high-speed generator 802 also has a frequency of 60 Hz and, thus, will be compatible with the local AC power grid. Other operating frequencies are also possible.

After the flow of working fluid has expanded through the high-pressure turbine section 204, the flow may then be directed through the low-pressure turbine section 208. Similar to the process described above, the flow of the working fluid may be directed over the bucket stages within the low-pressure turbine section 208, thus transforming the energy contained in the working fluid into the mechanical energy of the rotating second shaft 220. The second shaft 220 may couple the low-pressure turbine section 208 to the low-speed generator 212 so that the rotation of the second shaft 220 induced by the flow of working fluid through the low-pressure turbine section 208 drives the low-speed generator 212. As described in more detail above, the low-speed generator 212 may be a generator that has greater than two poles such that the low-speed generator 212 may output electrical energy at a frequency that is compatible with the local AC power grid while receiving a shaft frequency that is much slower.

The embodiment described in FIG. 8 also may have a steam turbine 302 that is coupled to the second shaft 220 and that operates in much the same way as that described above for this particular system component. Further, the compressor 104 of FIG. 8 may include a high-pressure compressor section 602 and a low-pressure compressor section 606 that reside on separate shafts and that function the same was as that described above for this particular system component. That is, the high-pressure compressor section 602 may be coupled to the first shaft 216 and driven by the high-pressure turbine section 204 and the low-pressure compressor section 606 may be coupled to the second shaft 220 and driven by the low-pressure turbine section 208. Generally, in other regards, the system components of the power generating turbine system 800 may operate similarly to that described herein for the same system components in the other embodiments.

FIG. 9 is a schematic drawing illustrating a power generating turbine system 900, which has three individually functioning shafts, according to an alternative embodiment of the present application. As illustrated, in a conventional manner, a first shaft 902 may couple a high-pressure turbine section 904 to a high-pressure compressor section 905. A second shaft 906 may couple a mid-pressure turbine section 908 to a high-pressure compressor section 909 and a high-speed generator 802. A third shaft 910 may couple a low-pressure turbine section 912 to a low-speed generator 212. Note, as generally described above, other arrangements of the system components may be possible than the one illustrated in FIG. 9.

In use, the power generating turbine system 900 may operate as follows. The rotation of compressor blades within the high-pressure compressor section 905 and the low-pressure compressor section 909 may compress a flow of air. Energy then may be released when the compressed air is mixed with fuel and ignited in the combustor 120. The resulting flow of expanding hot gases from the combustor 120 then may be directed over the buckets within the high-pressure turbine section 904, thus transforming the energy contained in the hot flow of gases into the mechanical energy of the rotating first shaft 902. The first shaft 902 may be coupled to the high-pressure compressor section 904 so that the rotation of the first shaft 902 induced by the flow of working fluid through the high-pressure turbine section 902 drives the high-pressure compressor section 905. Because the high-pressure turbine section 905 is not coupled to a generator, its operating frequency is not constrained to any particular level, which thus may allow it to operate at whatever frequency is most efficient for the system. In some embodiments, the operating frequency for the high-pressure turbine section 905 may be at least approximately 50 Hz. Of course, with no gear box in the system, the operating frequency of the high-pressure compressor section 905 will be the same as the frequency of the high-pressure turbine section 904. In other embodiments, the operating frequency for the high-pressure turbine section 904 at least approximately 70 Hz.

After the flow of working fluid has expanded through the high-pressure turbine section 904, the flow may then be directed through the mid-pressure turbine section 908. Similar to the process described above, the flow of the working fluid may be directed over the bucket stages within the mid-pressure turbine section 908, thus transforming the energy contained in the working fluid into the mechanical energy of the rotating second shaft 906. The second shaft 906 may couple the mid-pressure turbine section 908 to the low-pressure compressor section 909 so that the rotation of the second shaft 906 induced by the flow of working fluid through the mid-pressure turbine section 908 drives the low-pressure compressor section 909.

The second shaft 906 also may be coupled to the high-speed generator 802 so that the rotation of the shaft 906 induced by the flow of working fluid through the mid-pressure turbine section 908 drives the high-speed generator 802. In some embodiments, because the mid-pressure turbine section 908 is coupled to the high-speed generator 802, its operating frequency may be approximately 60 Hz such that electrical energy produced by the high-speed generator 802 also has a frequency of 60 Hz and, thus, will be compatible with the local AC power grid. Other similar operating frequencies are also possible.

After the flow of working fluid has expanded through the mid-pressure turbine section 908, the flow may then be directed through the low-pressure turbine section 912. Similar to the process described above, the flow of the working fluid may be directed over the bucket stages within the low-pressure turbine section 912, thus transforming the energy contained in the working fluid into the mechanical energy of the rotating third shaft 910. The third shaft 910 may couple the low-pressure turbine section 912 to the low-speed generator 212 so that the rotation of the third shaft 910 induced by the flow of working fluid through the low-pressure turbine section 912 drives the low-speed generator 212. As described in more detail above, the low-speed generator 212 may be a generator that has greater than two poles such that the low-speed generator 212 may output electrical energy at a frequency that is compatible with the local AC power grid while receiving a shaft frequency that is much slower.

The embodiment described in FIG. 9 also may have a steam turbine 302 that is coupled to the third shaft 910 and that operates in much the same way as that described above for this particular system component. Generally, in other regards, the system components of the power generating turbine system 900 may operate similarly to that described herein for the same system components in the other embodiments.

From the above description of preferred embodiments of the invention, those skilled in the art will perceive improvements, changes and modifications. Such improvements, changes and modifications within the skill of the art are intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

We claim:

1. A power generating turbine system, the system comprising:
an axial compressor that compresses a flow of air that is then mixed with a fuel and combusted in a combustor such that the resulting flow of hot gas is directed through a turbine;
wherein:
the turbine comprises a low-pressure turbine section and a high-pressure turbine section;
the high-pressure turbine section is coupled via a first shaft to the axial compressor such that in operation the high-pressure turbine section drives at least a part of the axial compressor;
the high-pressure turbine section is coupled via the first shaft to a high-speed generator such that in operation the low-pressure turbine section drives the high-speed generator; and
the low-pressure turbine section is coupled via a second shaft to a low-speed generator such that in operation the low-pressure turbine section drives the low-speed generator.

2. The power generating turbine system according to claim 1, wherein the high-pressure turbine section comprises between 1 to 2 stages and the low-pressure turbine section comprises between 2 to 4 stages.

3. The power generating turbine system according to claim 1, wherein:
the high-pressure turbine section is configured to operate when the pressure of the flow of the working fluid therethrough is between approximately 260 to 450 psi; and
the low-pressure turbine section is configured to operate when the pressure of the flow of the working fluid therethrough is between approximately 50 to 150 psi.

4. The power generating turbine system according to claim 1, wherein:
the turbine comprises multiple stages; and
the high-pressure turbine section comprises the forward stages of the turbine and the low-pressure turbine section comprises the aft stages of the turbine.

5. The power generating turbine system according to claim 1, wherein the low-speed generator comprises a four-pole generator.

6. The power generating turbine system according to claim 1, wherein the low-speed generator comprises a six-pole generator.

7. The power generating turbine system according to claim 1, wherein the low-speed generator comprises an eight-pole generator.

8. The power generating turbine system according to claim 1, wherein the high-speed generator comprises a two-pole generator

9. The power generating turbine system according to claim 1, wherein the general operating frequency of the low-pressure turbine section and the low-speed generator is approximately 25 to 30 Hz.

10. The power generating turbine system according to claim 1, wherein the general operating frequency of the high-pressure turbine section, the axial compressor, and the high-speed generator is approximately 50 to 60 Hz.

11. The power generating turbine system according to claim 1, further comprising a steam turbine;
wherein the steam turbine is coupled via the second shaft to the low-speed generator such that in operation both the low-pressure turbine section and the steam turbine drive the low-speed generator.

12. The power generating turbine system according to claim 11, wherein the steam turbine is a low-pressure steam turbine.

13. The power generating turbine system according to claim 12, wherein the general operating frequency of the low-pressure steam turbine is approximately 25 to 30 Hz.

14. The power generating turbine system according to claim 1, wherein:
the axial compressor comprises a low-pressure compressor section and a high-pressure compressor section;
the low-pressure turbine section is coupled via the second shaft to the low-pressure compressor section such that in operation the low-pressure turbine section drives the low-pressure compressor section; and
the high-pressure turbine section is coupled via the first shaft to the high-pressure compressor section such that in operation the high-pressure turbine section drives the high-pressure compressor section.

15. The power generating turbine system according to claim 14, wherein:
the general operating frequency of the low-pressure turbine section, the low-speed compressor section, and the low-speed generator is approximately 25 to 30 Hz; and
the general operating frequency of the high-pressure turbine section, the high-speed compressor section, and the high-speed generator is approximately 50 to 60 Hz.

16. A power generating turbine system, the system comprising:
a turbine that includes two sections, a high-pressure turbine section and a low-pressure turbine section that each reside on a separate shaft;
an axial compressor that compresses a flow of air that is then mixed with a fuel and combusted in a combustor such that the resulting flow of hot gas is directed through the turbine;
a two-pole generator;
a four-pole generator;
a first shaft that couples the high-pressure turbine section to the axial compressor and the two-pole generator such that, in operation, the high-pressure turbine section drives the axial compressor and the two-pole generator; and
a second shaft that couples the low-pressure turbine section to the four-pole generator such that, in operation, the low-pressure turbine section drives the four-pole generator.

17. The power generating turbine system according to claim 16, wherein the general operating frequency of the low-pressure turbine section and the low-speed generator is approximately 25 to 30 Hz.

18. The power generating turbine system according to claim 16, wherein the general operating frequency of the high-pressure turbine section, the axial compressor, and the high-speed generator is approximately 50 to 60 Hz.

19. The power generating turbine system according to claim 16, further comprising a steam turbine;
wherein the steam turbine is coupled via the second shaft to the low-speed generator such that in operation both the low-pressure turbine section and the steam turbine drive the low-speed generator.

20. The power generating turbine system according to claim 16, wherein:
the axial compressor comprises a low-pressure compressor section and a high-pressure compressor section;
the low-pressure turbine section is coupled via the second shaft to the low-pressure compressor section such that in operation the low-pressure turbine section drives the low-pressure compressor section;
the high-pressure turbine section is coupled via the first shaft to the high-pressure compressor section such that in operation the high-pressure turbine section drives the high-pressure compressor section;
the general operating frequency of the low-pressure turbine section, the low-speed compressor section, and the low-speed generator is approximately 25 to 30 Hz; and
the general operating frequency of the high-pressure turbine section, the high-speed compressor section, and the high-speed generator is approximately 50 to 60 Hz.
